(19) United States
(12) Patent Application Publication
(10) Pub. No.: US 2005/0272439 A1
(43) Pub. Date: Dec. 8, 2005

(54) Mobile localization in gsm networks

(76) Inventors: Agostino Picciriello, Milano (IT); Katia Picciriello, Milano (IT); Giulio Monguzzi, Milano (IT); Maurizio Moretto, Milano (IT); Jacob Kristian Osterling, Jarfalla (SE)

Correspondence Address: ERICSSON INC., 6300 LEGACY DRIVE, M/S EVR C11, PLANO, TX, 75024, US

(21) Appl. No.: 10/498,200

(22) PCT Filed: Dec. 23, 2002
(86) PCT No.: PCT/SE02/02452

§ 371 Date: Dec. 17, 2004

(30) Foreign Application Priority Data
Dec. 21, 2001 (SE) 0104417-1

(51) Int. Cl. H04Q 7/20

(52) U.S. Cl. 455/456.1

(57) ABSTRACT

A positioning system and an antenna in a cellular mobile network, for operators that requires no modifications to standard phones and terminals used in said network and capable of using a range of different positioning methods, comprising one or several LMU systems that makes radio measurement (GSM and GPS)and transmit measurement data needed in the geographical positioning procedure of said phone or said terminal. Said LMU systems are composed of two parts a main box unit, comprising—measure receiver block—mobile station block (when an air interface is used)—main functionality and GPS block—digital signal block antenna unit, which can be placed in a remote position.

The present invention relates to a positioning system in a cellular mobile network, for operators that requires no modifications to standard phones and terminals used in said network and capable of using a range of different positioning methods, comprising one or several LMU systems that makes radio measurement (GSM and GPS) and transmit measurement data needed in the geographical positioning procedure of said phone or said terminal.

There is a widening range of cellular communications applications where it is becoming important to know the geographic position of the mobile stations (terminals) being used. For example, it is important to know the position of mobile stations being used to make or respond to emergency calls. Similarly, it is important to know the position of mobile stations being used in vehicles for fleet management purposes (e.g., taxis).

The available solutions are usually divided into two groups, terminal-based and network-based solutions.

Terminal Based Solutions:

GPS—Global Positioning System, uses a set of satellites to locate a user's position. This system has been used in vehicle navigation systems as well as dedicated handheld devices for some time, and now it's making it's way into the Mobile Internet. With GPS, the terminal gets positioning information from a number of satellites (usually 3-4). This raw information can then either be processed by the terminal or sent to the network for processing, in order to generate the actual position. The US government previously distorted the satellite clock signals to reduce accuracy with the Selective Availability (SA) mask; but, that was removed in May 2000. This means that GPS now can achieve around 5 m-40 m accuracy provided there is a clear view of the sky.

A-GPS—Network Assisted GPS uses fixed GPS receivers that are placed at regular intervals, every 200 km to 400 km to fetch data that can complement the readings of the terminal. The assistance data makes it possible for the receiver to make timing measurements from the satellites without having to decode the actual messages.

E-OTD—Enhanced Observed Time Difference (E-OTD) only uses software in the terminal. To run the E-OTD algorithms in the idle mode (terminal is not handling a call) and in the dedicated mode (terminal is handling a call), new phones must be designed with additional processing power and memory. The E-OTD procedure uses the data received from surrounding base stations to measure the difference it takes for the data to reach the terminal. That time difference is used to calculate where the user is located relative to the base stations. This requires that the base station positions are known and that the data sent from different sites is synchronized. A way of synchronizing the base stations is via the use of fixed GPS receivers. The calculation can then either be done in the terminal or the network.

Network Based Solutions:

CGI-TA—Cell Global Identity (CGI) uses the identity that each cell (coverage area of a base station) to locate the user. It is often complemented with the Timing Advance (TA) information. TA is the measured time between the start of a radio frame and a data burst. This information is already built into the network and the accuracy is decent when the cells are small (a few hundred meters). For services where proximity (show me a restaurant in this area) is the desired information, this is a very inexpensive and useful method. It works with all existing terminals, which is a big advantage. The accuracy is dependent on the cell size and varies from 10 m (a micro cell in a building) to 500 m (in a large outdoors macro cell).

TOA—Uplink Time of Arrival (TOA) works in a very similar way as E-OTD, the difference being that the uplink data is measured (the data that is sent by the terminal). The base stations measure the time of arrival of data from the terminal. This requires that at least three monitoring base stations are available to perform the measurements. The base stations note the time difference and combine it with absolute time readings using GPS absolute time clocks. E-OTD and TOA might look very similar, but the key difference is that TOA supports legacy terminals. The drawback of TOA is that it requires monitoring equipment to be installed at virtually all of the base stations. This is potentially the most expensive of location procedures for operators to implement.

It is an object of the present invention to provide a network platform for determining the position of any mobile station or terminal within a mobile cellular telecommunications network, which give more accurate measurement of the parameters needed for position applications, which are used by telecommunication operators or other service providers and at the same time bring down the number of LMUs (Localisation measurement units) needed in the platform.

It is a further object of the present invention to provide for a deployment in which the LMU's are collocated with existing radio base stations (BTS's), which operators demand.

It is a yet futher object of the present invention to reduce the amount of interference to the receiver, which caused by interference from the wideband co-channel random noise emitted from the co-located BTS transmitter and from interference resulting from the LMU antenna being mounted at nearly BTS antenna height.

According to a first aspect of the present invention, there is provided a positioning system in a cellular mobile network, for operators that requires no modifications to standard phones and terminals used in said network and capable of using a range of different positioning methods, comprising one or several LMU systems that makes radio measurement (GSM and GPS)and transmit measurement data needed in the geographical positioning procedure of said phone or said terminal. said LMU systems are composed of two parts
a main box unit, comprising as a minimum;
   measure receiver block
   main functionality and GPS block
   digital signal block
      antenna unit, which can be placed in a remote position.
said antenna unit is a separate unit comprising;
   a GSM antenna
   a GPS antenna with LNA included
said GSM antenna is a adaptive antenna
said adaptive antenna is a multi-beam antenna in order to improve the carrier to interference ratio (CIR) experienced at the LMU site of the received signal from the target BTS or to suppress reflections.
said multi-beam antenna has dual polarisation with both spatial beams and polarisation beams.
said multi-beam antenna is a three sector patch antenna with polarity diversity for each path.
a antenna-beam is selected per BTS and based on the radio environment of each BTS.

According to a second aspect of the present invention, there is a antenna in a positioning system in a cellular mobile network, for operators that requires no modifications to standard phones and terminals used in said network and capable of using a range of different positioning methods, comprising one or several LMU systems that makes radio measurement (GSM and GPS) and transmit measurement data needed in the geographical positioning procedure of said phone or said terminal. Said antenna is a adaptive antenna and situated in said LMU system.
said adaptive antenna is a multi-beam antenna in order to improve the carrier to interference ratio (CIR) experienced at the LMU site of the received signal from the target BTS or to suppress reflections.
said multi-beam antenna has dual polarisation with both spatial beams and polarisation beams.
said multi-beam antenna is a three sector patch antenna with polarity diversity for each path.
a antenna-beam is selected per GSM antenna is a adaptive antenna BTS and based on the radio environment of each BTS.
said antenna-beam is selected on prior knowledge of the radio environment.
said antenna beam selection is based on prior measurements on a BTS.
a algorithm tries different beams at an installation procedure and then sticks to the best beam.
said beam is reselected at given instances to adapt to modified radio environments.
said antenna is a tri-sector antenna in which each sector is sequentially selected by a switch while the remaining two are inactive.
said antenna unit is collocated with a basstation in order to minimise interference.
information received on different beams, at different times, are combined to form the desired information about said BTS.
more than one multi-beam antenna is connected in the system.
said multi-beam antennas is serial connected.
said antennas is connected in a star.
said multi-beam antenna using a switch output dedicated for the serial antenna connection and just only one antenna unit has the GPS antenna.
said multi-beam antenna receive a control word, for selection of a specific antenna beam, have a field to select the multi-beam antenna in the chain and another field to activate the requested beam.
said connection have a distribution box, that allows connecting a set of multi-beam antennas in a star configuration, splitting the GSM signal.
said multi-beam antenna receive a control word, for selection of a specific antenna beam, have one field to select the distribution box output and a second field to address the antenna beam and one of said antenna units has the GPS antenna.

Advantage of the invention is for the first that it is easy to test a good place for the antenna if the LMU system is divided into two parts. The benefits obtained using a switched tri-sector antenna is a LMU deployment density in order of 1:3 (1 LMU per 3 BTS sites) in order to be able to “hear” all cells with the required CIR (needed to decode the BCCH channel). In fact, since each sector of the LMU antenna is selected separately a smart spatial filter is implemented and exploiting the polarisation diversity, the base stations are heard with a CIR much greater than the case of a omnidirectional antenna. As a result, the density of LMU can be reduced respect to the 1:1 deployment. Moreover, increasing the number of the antenna, e.g. six sectors, the performance improves. Another benefit is the improved measurement accuracy by suppression of reflection near the LMU.

Embodiments of the invention will now be described, by way of example, with reference to the accompanying drawings, in which:

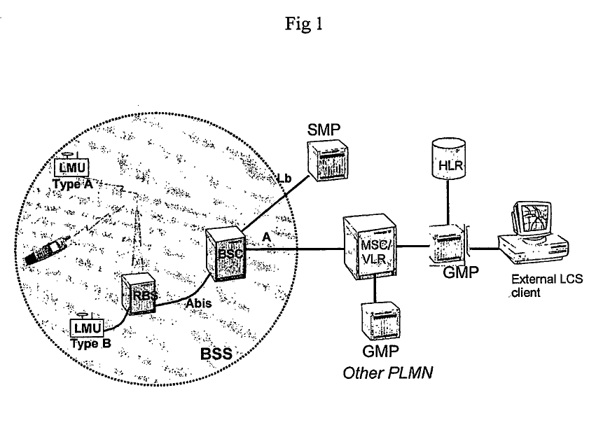

FIG. 1 illustrates the LCS System Architecture.

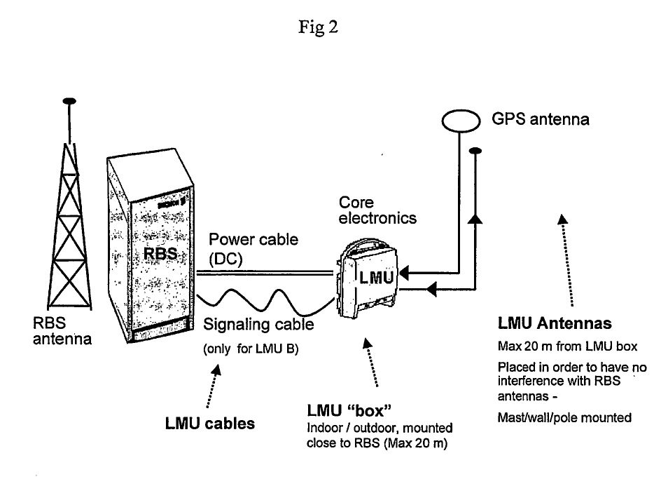

FIG. 2 illustrates the Location Measurement Unit.

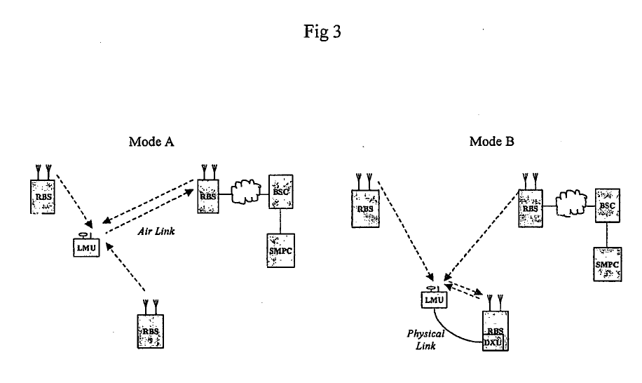

FIG. 3 illustrates, in schematic form the two possible LMU modes: mode A and mode B.

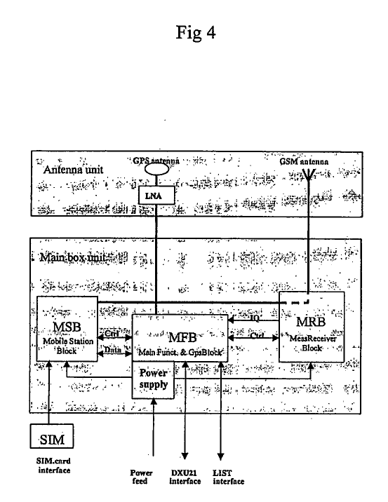

FIG. 4 shows the LMU Hardware Architecture.

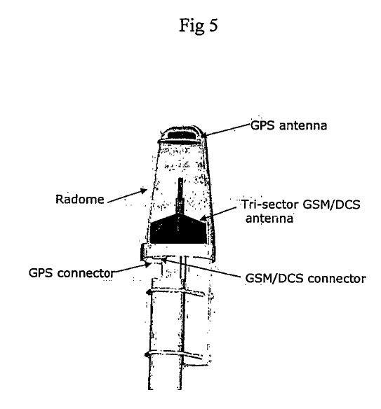

FIG. 5 illustrates Antenna Unit.

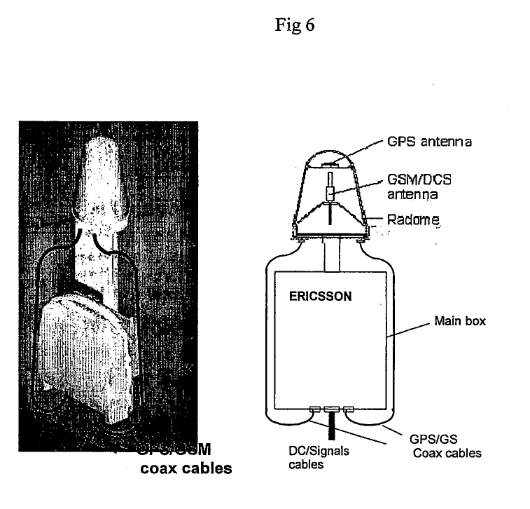

FIG. 6 shows the Antenna Unit: GSM/GPS coax cables.

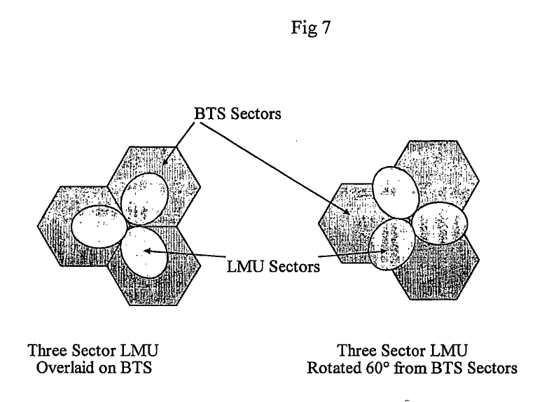

FIG. 7 illustrates, in schematic form, Tri-sector LMU antenna.

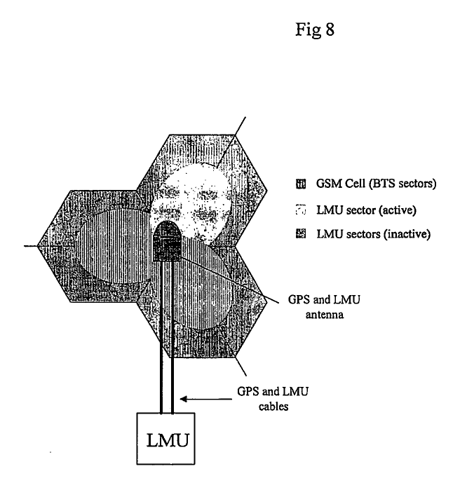

FIG. 8 illustrates, in schematic form, Switched tri-sector patch LMU antenna.

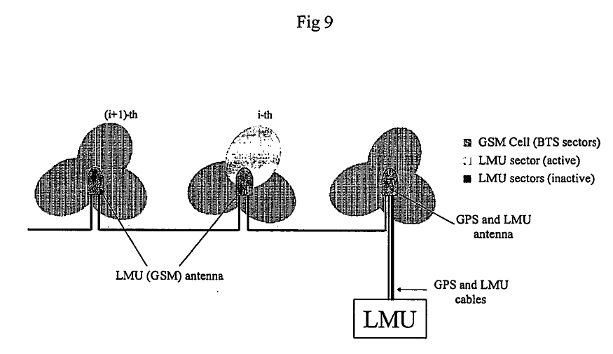

FIG. 9 illustrates, in schematic form, a daisy chain GSM antenna configuration.

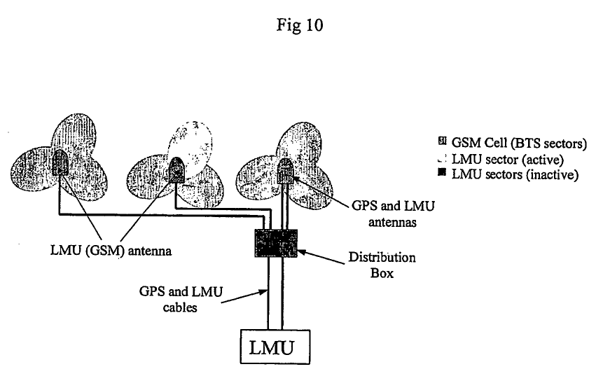

FIG. 10 illustrates, in schematic form, a LMU antenna with a distribution box.

A glossary of the abbreviations used in this patent specification is set out below to facilitate an understanding of the present invention.
ATD Absolute Time Difference
BSIC Base Station Identity Code
CIR Carrier to Interference Ratio
E-OTD Enhanced Observed Time Difference
FN Frame Number
GPS Global Positioning System
LCS LoCation Services
LMU Localisation Measurement Unit
MLC Mobile Location Centre
SMLC Serving Mobile Location Centre
LNA Low Noise Amplifier

The present invention is a positioning system in a cellular mobile network for determining the location of a mobile station and more specific the LMU architecture with its antenna unit.

In FIG. 1 is shown the whole LoCation system (LCS) architecture The system consists of these major parts:
Core Network (CN)
Base Transceiver Station (BTS)
Base Station Controller (BSC)
Mobile Switching Centre (MSC)
Location Measurement Unit (LMU)
Serving Mobile Location Centre (SMLC)
Mobile Station (MS)
Gateway mobile location centre (GMLC)

LCS is logically implemented on the GSM structure through the addition of one network node, the Mobile Location Centre (MLC). It is necessary to name a number of new interfaces.

A generic LCS logical architecture is shown in FIG. 1. LCS generic architecture can be combined to produce LCS architecture variants.

Turning now to the complete functional description about how the LCS is implemented in the GSM network architecture.

The BTS is only involved in the physical support and signalling handling of positioning procedures (transparent mode).

BSC

The BSC is only involved in the physical support and signalling handling of positioning procedures.

MS

The MS may be involved in the various positioning procedures.

LMU

An LMU makes radio measurements (GSM and GPS) in order to support one or more positioning methods. These measurements provide assistance data specific to all MSs in a certain geographic area. LMU measures the air-interface timing of one or several RBSs and relates the respective timings to an absolute time supplied by GPS.

SMLC

The Serving Mobile Location Centre (SMLC) contains functionality required to support LCS. In one PLMN, there may be more than one SMLC. The SMLC manages the overall co-ordination and scheduling of resources required to perform positioning of a mobile. It also calculates the final location estimate and accuracy.

MSC

The MSC contains functionality responsible for MS subscription authorisation and managing call-related and non-call related positioning requests of GSM LCS. The MSC is accessible to the GMLC via the Lg interface and the SMLC via the Ls interface.

HLR

The HLR contains LCS subscription data and routing information. The HLR is accessible from the GMLC via the Lh interface. For roaming MSs, HLR may be in a different PLMN that the current SMLC.

GMLC

The Gateway Mobile Location Centre (GMLC) contains functionality required to support LCS. In one PLMN, there may be more than one GMLC.

The GMLC provides an interface to external LCS clients that request the position of an MS. It is responsible for the registration authorization of the LCS client and for providing the final location estimate to the LCS client.

Turning now to the System Architecture as illustrated in FIG. 2.

The LMU entity will work with GSM systems for 850/900/1800/1900 MHz, which will be connected to the existing GSM core network (BSC, TRAU, MSC, MLC). The LMU (Location Measurement Unit) is integrated into the present GSM structure and network to implementing Location Services(LCS).

The LMU architecture is split in two main parts, the Main Box Unit and the Antenna Unit. The main functionality's are gathered in a Main Box Unit, which consists of:
Measure Receiver Block;
Mobile Station Block;
Main Functionality and GPS Block;
Digital Signal Processing Block.

A GSM part in the LMU antenna unit is a tri-sector antenna in which each sector is can be individually selected by a switch while the remaining two are inactive. In this way a sort of spatial filter is implemented. Moreover, the diversity polarisation of the antenna is used to improve the hearability of the base stations. As a result of these two approaches is an LMU deployment density in the order of 1:3 (1 LMU per 3 BTS sites), which permits to “hear” all cells (BTS's) with the required CIR. Finally, the switch of the LMU antenna selects a sector upon receiving a control word superimposed on the GPS power feeding. No additional cable is required.

A wired interface to the BTS (LMU-RBS Data Interface) is also provided.

The LMU is able to work in two possible modes as illustrated in FIG. 3.

Mode A

In this mode LMU exchanges data with the BTS by means of Um interface and communicates with SMPC via Over-The-Air (OTA) interface using SMS. Moreover, it is independent of the BTS implementation and is defined both for E-OTD and A-GPS. In this mode adaptive antennas is used to communicate with the basstations.

Mode B

In this mode LMU exchanges data with the BTS by means of LMU-RBS Data Interface and communicates with SMPC via BTS using CF-OML (Central Function Operation & Maintenance Link). Moreover, it is defined both for E-OTD and A-GPS and may be used for network synchronisation.

In the following we shall describe, with reference to FIG. 4, the LMU Hardware Architecture.

The LMU hardware is split in two separated units.
Main box unit
Antenna unit

The main box unit contains:
Measurement Receiver Block, RF part (MRB). These consist of all the RF functional parts involved in time of arrival estimation of SCH bursts.
Mobile Station Block (MSB for mode A LMU) . This is used as an “air modem” for the communication with SMLC in A mode.
Main Functionality and GPS Block (MFB). These consist of an ARM Main processor for SMLC interworking and O&M, a GPS receiver for time synchronisation, a reference oscillator for GSM frequency drift measurements, a Digital Signal Processor for the computation of Time Of Arrival measurements, and a programmable FPGA logic for data interfacing and pre-processing functions.

Turning now to the antenna unit which is a separate unit as illustrated in FIG. 5.
It contains GSM antenna that is a tri-sector patch antenna.
GPS antenna with LNA included.

In FIG. 6 is shown how the antenna unit is connected to the main box unit by means of two cables: the GSM/GPS coax cables.

GSM Antenna for LMU Antenna Unit

In GSM networks the deployment of LMU's, recommended by the operators, is the deployment in which the LMU's are collocated with existing radio base stations (BTS's).

This choice introduces a significant amount of interference to the receiver, which caused by two sources.
The first source of interference is due to the wideband co-channel random noise emitted from the co-located BTS transmitter.
The second source of interference results from the LMU antenna being mounted at nearly BTS antenna height, resulting in a pathloss coefficient that is much less than what is used for mobility coverage prediction. This results in interference from co-channel BTS's much greater than what a mobile on the ground would see.

Since the LMU is required to accomplish bit-wise detection of the BSIC and Frame Number with high probability, C/I levels in the order of 9 dB are needed. This would not be a problem if the LMU were only required to “listen” to its own co-located BTS. In this case, a simple omni-directional antenna, combined with a GPS antenna, would be required for the LMU.

If the LMU is required to “listen” to adjacent BTS's in the case of an LMU outage, or for a less than 1:1 LMU deployment density, then the interference described above becomes an LMU “hearability” problem. In this case, the C/I for the BCCH measurement can be enhanced by using directional antennas, configured e.g. in a tri-sector arrangement, with the LMU sectors either overlapping the BTS sectors, or rotated 60° from BTS sector direction as illustrated in FIG. 7.

In FIG. 8 is shown a further enhancement which can be obtained using a switched e.g. tri-sector patch antenna in which each sector is separately selected while the remaining two are inactive. This kind of antenna implements a smart spatial filter because the experienced interference is only produced by the BTS placed in the area covered by the selected (active) LMU sector while all the others BTS (interference sources) are rejected, i.e. an interference rejection is obtained.

As a result of the use of switched multi-beam antenna, the C/I experienced is much greater than what would be measured with a simple directional antenna.

The switch of the LMU antenna selects a sector on receiving a command by means of a control word superimposed on the GPS power feeding.

Finally, each patch sector is polarized both at +45° and at −45°. That permits to realize polarization diversity: During the propagation on the radio channel, part of the transmitted signal energy migrates in the polarization at +45° and the other part in the polarization at −45°. The interfering BTS and the BTS we want to listen to will have different polarisation at the antenna. Therefore, selecting a favourable polarisation “beams” will allow for C/I improvement even if the interfering BTS is within the same spatial “beam”.

Multi GSM Antenna for the LMU Antenna Unit

The LMU antenna unit has moreover the flexibility to connect more than one GMS antenna. This configuration is adopted when a single GSM multi-beam antenna cannot guarantee a satisfactory coverage in terms of CIR, because of the presence of obstacles. Two different connection schemes can be implemented:
GSM antennas serial connected
GSM antennas connected in star configuration

Installing more than one multi-beam antenna (serial or star connected) an improvement in the C/I, experienced at LMU from the target BTS, is more likely obtained.

a) Multi LMU—GSM antenna serial connected (daisy chain configuration)

The configuration with GSM switched multi-beam antennas serial connected is shown in FIG. 9. It is also called daisy chain configuration.

The element i-th of the multi-beam antenna chain is linked to the previous element (i-1)-th using a switch output dedicated for the serial antenna connection and just only one antenna unit has the GPS antenna.

Using the daisy chain configuration the control word, to select a specific antenna beam (the beam from the antenna in the middle in FIG. 9), must have a field to select the multi-beam antenna in the chain and another field to activate the requested beam.

b) Multi LMU—GSM Antenna Connected in Star Configuration (Distribution Box)

The configuration with GSM antennas in star connection represents an alternative solution to the daisy chain proposal. This connection requires a distribution box, that allows connecting a set of multi-beam antennas in a star configuration, splitting the GSM signal only as shown in FIG. 10.

Turning now to the configuration in FIG. 10. In this configuration the control word requires one field to select the distribution box output and a second field to address the antenna beam. Finally, just one antenna unit has the GPS antenna.

The Distribution Box proposal offers several advantages compared with the daisy chain configuration.
Modularity, in case the use of more than one multi-beam antenna is necessary; the distribution box can be connected without making any changes.
No change is required to the multi-beam antenna as instead it is necessary for the daisy chain configuration.
In the star configuration each GSM signal is attenuated of about the same amount (in the distribution box) while in the daisy configuration the attenuation increases progressively towards the last multi-beam antenna of the connection.
The same number of lightening protection is required by the two configurations.
   Beam Selection

The simplest beam selection algorithm is that the LMU is ordered by an external source (operator or SMLC) which antenna beam to use for which BTS.

To simplify installation, the external source could instead state the relations between the different BTSs to listen to e.g. BTS2 is 50 degrees to the right compared to BTS1. If the LMU finds BTS1 or BTS2, it could easily calculate which beam to use for the other BTS. The installer who uses this algorithm does not have to know the actual beam coverage per beam.

A more useful algorithm is that the LMU evaluates which beam is suitable per BTS. The evaluation could be made once, at installation, or at regular basis, e.g. once an hour plus at fault cases.

The evaluation criteria is a combinations of two:
The C/I experienced in the beam
The multipath environment of the beam

To detect and decode the BSIC and Frame Number, a good C/I is required. However, the BSIC and C/I need only to be decoded once per BTS to “lock on” to the BTS BCCH. The detection is required to determine that the received burst originates from the wanted BTS (BSIC check), and to find a rough estimate of the absolute timing of the BTS (Frame Number).

To “track” the time drift of the BTS, the SCH burst is received regularly and reported to the SMLC. Once “locked on”, the BSIC and Frame Number do not have to be decoded (could be checked occasionally to see that we are still tracking the right BTS though).

The tracking accuracy is essential for the positioning accuracy. The two criteria above contributes different to the accuracy:
A bad C/I makes it difficult to accurately determine when, in the received burst, the SCH burst is placed. The signal processing in the LMU looks for the first occurrence in the received burst data of the SCH by correlation. The correlation accuracy is dependent on C/N or C/I.
If the first strong occurrence of the SCH in the burst data is not the direct wave but a strong reflection, the LMU will track the strong reflection. A systematic error is then added to the measurement: e_systematic=t_tracked_reflection−t_direct_wave.
A very heavy multipath can also deteriorate the accuracy of the correlator since reflections received very close in time sometimes cannot be resolved fully, and since reflections very far away may act as an interferer.

The conclusion is that mulipath with no direct wave gives a systematic error and interference and multipath with a direct wave gives a time-varying uncertainty.

The combined error should be evaluated when selecting beam per BTS.

Some special cases exists:
When decoding BSIC and FN, only bit error rate is of importance. The selected beam for BSIC/FN decoding is not necessarily the same as for tracking.
When using over-lapping LMU coverage areas or other radio measurement units, the SMLC may use its redundant information to calibrate the systematic error. Only C/I is then of interest.

Another approach is to let the LMU do measurements on both beams and try to estimate the e_systematic. This is possible to do with good accuracy since the systematic error is constant and the measurements can thus be averaged for a very long time—even days. An important point is that if the interference may vary over time (e.g. day/night) so at some instances, the measurement condition for the direct wave may be very good.

Multipath Rejection

Another benefit of using a multi-beam antenna in the LMU is that reflections from near the LMU most likely falls outside the selected narrow beam. The reflection will therefore not cause inaccuracies in the correlation of the SCH burst. Higher measurement accuracy is achieved and thus better positioning performance.

Mode A Communication

When the LMU operates in mode A, it will communicate with the SMLC using the air interface. A suitable beam for reception of data via the air interface must be selected. The selection is based on which beam gives the lowest bit error rate.

The same beam is chosen for LMU transmission of data onto the air interface. If the BSS reports a bad radio environment (RXQUAL), the LMU changes beam until a good environment is found. The algorithm will make sure a suitable beam is selected uplink (LMU→BSS) which will allow for a very low output power from the LMU. This will be a benefit will for the operator, as LMU will therefor impose very low radio interference in the network.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A positioning system in a cellular mobile network, comprising one or several Location Measurement Unit (LMU) systems that makes radio measurement (Global System for Mobile Communication (GSM) and Geosynchronous Positioning Satellite (GPS)) and transmit measurement data needed in the geographical positioning procedure of a phone or a terminal, wherein said LMU systems each comprise:
a main box unit, comprising as minimum
measure receiver block—main functionality and GPS block and
digital signal block antenna unit, which can be placed in a remote position and;
an antenna unit, which can be placed in a remote position.

2. The positioning system of claim 1, wherein said antenna unit is a separate unit comprising;
a GSM antenna
a GPS antenna with LNA included

3. The positioning system of claim 1, wherein said GSM antenna is a adaptive antenna.

4. The positioning system of claim 3, wherein said adaptive antenna is a multi-beam antenna in order to improve the carrier to interference ratio (CIR) experienced at the LMU site of the received signal from the target BTS or to suppress reflections.

5. The Positioning system of claim 4, wherein said multi-beam antenna has dual polarisation with both spatial beams and polarisation beams.

6. The positioning system of claim 5, wherein said multi-beam antenna is a three sector patch antenna with polarity diversity for each path.

7. The positioning system of claim 6, wherein an antenna-beam is selected to one BTS and based on the radio environment of each BTS.

8. The positioning system of claim 7, wherein said antenna-beam is selected on prior knowledge of the radio environment.

9. The positioning system of claim 7, wherein said beam to use in said antenna unit is controlled by said main box unit.

10. The positioning system of claim 7, wherein said beam to use in said antenna unit is selected by means of a superimposed control word on a RF feeder between said antenna unit and said main box unit.

11. The positioning system of claim 9, wherein said main box unit receive a table of BTS co-ordinates from MPS and then predict or find correct antenna beam direction for one of the BTS in the list.

12. The positioning system of claim 7, wherein said antenna beam selection is based on prior measurements on the BTS.

13. The positioning system of claim 7, wherein a algorithm tries different beams at an installation procedure and then sticks to the best beam.

14. The positioning system of claim 13, wherein said beam is reselected at given instances to adapt to modified radio environments.

15. The positioning system of claim 1, wherein said GSM antenna is a tri-sector antenna in which each sector is individually selected by a switch while the remaining two are inactive.

16. The positioning system of claim 1, wherein the LMU deployment density is in the order of 1:3 (1 LMU per 3 BTS sites) which permits to hear all cells(BTS s) with the required CIR.

17. The positioning system of claim 1, wherein said LMU is able to work in two modes.

18. The positioning system of claim 17, wherein said two modes comprise:
Mode A: LMU exchanges data with the BTS by means of Um interface and communicates with SMPC via Over-The-Air (OTA) interface using SMS and is independent of the BTS implementation and is defined both for E-OTD and A-GPS and
Mode B: LMU exchanges data with the BTS by means of LMU-RBS Data Interface and communicates with SMPC via BTS using CF-OML (Central Function Operation & Maintenance Link)

19. The positioning system of claim 17, wherein said antenna unit is placed remote from the main box which is collocated with the base station in order to minimise interference.

20. The positioning system of claim 7, wherein information received on different beams, at different times, are combined to form the desired information about said BTS.

21. An antenna unit in a positioning system in a cellular mobile network, for operators that require no modifications to standard phones and terminals used in said network and capable of using a range of different positioning methods, comprising one or several LMU systems that makes radio measurement (GSM and GPS) and transmit measurement data needed in the geographical positioning procedure of said phone or said terminal, wherein said antenna is an adaptive antenna and situated in said LMU system.

22. The antenna of claim 21, wherein said adaptive antenna is a multi-beam antenna for improving the carrier to interference ratio (CIR) experienced at the LMU site of the received signal from the target BTS or to suppress reflections.

23. The antenna of claim 22, wherein said multi-beam antenna has dual polarisation with both spatial beams and polarisation beams.

24. The antenna of claim 22, wherein said multi-beam antenna is a three sector patch antenna with polarity diversity for each path.

25. The antenna of claim 24, wherein an antenna-beam is selected per GSM antenna is an adaptive antenna BTS and based on the radio environment of each BTS.

26. The antenna of claim 25, wherein said antenna-beam is selected on prior knowledge of the radio environment.

27. The antenna of claim 25, wherein said antenna beam selection is based on prior measurements on a BTS.

28. The antenna of claim 25, wherein an algorithm tries different beams at an installation procedure and then sticks to the best beam.

29. The antenna of claim 25, wherein said beam is reselected at given instances to adapt to modified radio environments.

30. The antenna of claim 21, wherein said antenna is a tri-sector antenna in which each sector is individually selected by a switch while the remaining two are inactive.

31. The antenna of claim 30, wherein information received on different beams, at different times, are combined to form the desired information about said BTS.

32. The antenna of claim 30, wherein more than one multi-beam antenna is connected in the system.

33. The antenna of claim 32, wherein said multi-beam antennas is serial connected.

34. The antenna of claim 32, wherein said antennas is connected in a star.

35. The antenna of claim 33, wherein said multi-beam antenna using a switch output dedicated for the serial antenna connection and just only one antenna unit has the GPS antenna.

36. The antenna of claim 33, wherein said multi-beam antenna receive a control word, for selection of a specific antenna beam, have a field to select the multi-beam antenna in the chain and another field to activate the requested beam.

37. The antenna of claim 34, wherein said connection have a distribution box, that allows connecting a set of multi-beam antennas in a star configuration, splitting the GSM signal.

38. The antenna of claim 34, wherein said multi-beam antenna receive a control word, for selection of a specific antenna beam, have one field to select the distribution box output and a second field to address the antenna beam and one of said antenna units has the GPS antenna.
